(19) United States
(12) Patent Application Publication
(10) Pub. No.: US 2014/0137734 A1
(43) Pub. Date: May 22, 2014

(54) CROSS-LINKED POLYIMIDE MEMBRANES FOR SEPARATIONS

(71) Applicant: UOP LLC, Des Plaines, IL (US)

(72) Inventors: Chunqing Liu, Arlington Heights, IL (US); Howie Q. Tran, Skokie, IL (US)

(73) Assignee: UOP LLC, Des Plaines, IL (US)

(21) Appl. No.: 13/681,869

(22) Filed: Nov. 20, 2012

(51) Int. Cl. B01D 71/64; B01D 53/22

(52) U.S. Cl. CPC B01D 71/64; B01D 53/228
USPC 95/47; 95/45; 95/51; 95/55; 95/54; 95/52; 95/49; 95/53; 525/426

(57) ABSTRACT

The present invention discloses new types of poly(amidoamine) (PAMAM) dendrimer-cross-linked polyimide membranes and methods for making and using these membranes. The membranes are prepared by cross-linking of asymmetric aromatic polyimide membranes using a PAMAM dendrimer as the cross-linking agent. The PAMAM-cross-linked polyimide membranes showed significantly improved selectivities for CO₂/CH₄ compared to a comparable uncrosslinked polyimide membrane. For example, PAMAM 0.0 dendrimer-cross-linked asymmetric flat sheet poly(3,3′,4,4′-diphenylsulfone tetracarboxylic dianhydride-3,3′,5,5′-tetramethyl-4,4′-methylene dianiline) (DSDA-TMMDA) polyimide membrane showed CO₂ permeance of 135.2 A.U. and CO₂/CH₄ selectivity of 20.3. However, the un-cross-linked DSDA-TMMDA asymmetric flat sheet membrane showed much lower CO₂/CH₄ selectivity (16.5) and higher CO₂ permeance (230.8 GPU).

### BACKGROUND OF THE INVENTION

The present invention involves a new type of poly(amidoamine) (PAMAM) dendrimer-cross-linked polyimide membranes and methods for making and using these membranes. The PAMAM-cross-linked polyimide membranes described in the current invention are prepared by cross-linking of asymmetric aromatic polyimide membranes using PAMAM dendrimer as the cross-linking agent.

This invention relates to a new type of poly(amidoamine) dendrimer-cross-linked polyimide membranes with high permeance and high selectivity for separations and more particularly for natural gas upgrading.

Membrane-based technologies have advantages of both low capital cost and high-energy efficiency compared to conventional separation methods. Polymeric membranes have been proven to operate successfully in industrial gas separations such as separation of nitrogen from air and separation of carbon dioxide from natural gas.

Commercially available polymer membranes, such as cellulose acetate, polyimide, and polysulfone membranes formed by phase inversion and solvent exchange methods have an asymmetric integrally skinned membrane structure. See U.S. Pat. No. 3,133,132. Such membranes are characterized by a thin, dense, selectively semipermeable surface “skin” and a less dense void-containing (or porous), non-selective support region, with pore sizes ranging from large in the support region to very small proximate to the “skin.” However, fabrication of defect-free high selectivity asymmetric integrally skinned membranes is difficult. The presence of nanopores or defects in the skin layer reduces the membrane selectivity. One approach to reduce or eliminate the nanopores or defects in the skin layer of the asymmetric membranes has been the fabrication of an asymmetric membrane comprising a relatively porous and substantial void-containing selective “parent” membrane such as polysulfone or cellulose acetate that would have selectivity were it not porous, wherein the parent membrane is coated with a material such as a polysiloxane, a silicone rubber, or a UV-curable epoxysilicone in occluding contact with the porous parent membrane, the coating filling surface pores and other imperfections comprising voids (see U.S. Pat. No. 4,230,463; U.S. Pat. No. 4,877,528; U.S. Pat. No. 6,368,382).

In order to combine high selectivity and high permeability together with high thermal stability, new high-performance polymers such as polyimides (PIs), poly(trimethylsilylpropyne) (PTMSP), and polytriazole were developed. These new polymeric membrane materials have shown promising properties for separation of gas pairs like CO₂/CH₄, O₂/N₂, H₂/CH₄, and C₃H₆/C₃H₈. However, current polymeric membrane materials have reached a limit in their productivity-selectivity trade-off relationship. In addition, gas separation processes based on glassy polymer membranes frequently suffer from plasticization of the stiff polymer matrix by the sorbed penetrating molecules such as CO₂ or C₃H₆. Plasticization of the polymer is exhibited by swelling of the membrane structure and by a significant increase in the permeances of all components in the feed and decrease of selectivity occurring above the plasticization pressure when the feed gas mixture contains condensable gases. Plasticization is particularly an issue for gas fields containing high CO₂ concentrations and for systems requiring two-stage membrane separation.

U.S. 2005/0268783 A1 disclosed chemically cross-linked polyimide hollow fiber membranes prepared from a monoesterified polymer followed by final cross-linking after hollow fiber formation.

U.S. Pat. No. 4,931,182 and U.S. Pat. No. 7,485,173 disclosed physically cross-linked polyimide membranes via UV radiation. The cross-linked membranes showed improved selectivities for gas separations. However, it is hard to control the cross-linking degree of the thin selective layer of the asymmetric gas separation membranes using UV radiation technique, which will result in very low permeances although the selectivities are normally very high.

Therefore, it is still highly desirable to prepare commercially viable high selectivity asymmetric membranes for separations.

The present invention discloses a new type of poly(amidoamine) (PAMAM) dendrimer-cross-linked polyimide membranes and methods for making and using these membranes.

### SUMMARY OF THE INVENTION

A new type of poly(amidoamine) (PAMAM) dendrimer-cross-linked polyimide membranes with high selectivities for gas separations has been made.

The present invention generally relates to gas separation membranes and, more particularly, to high selectivity poly(amidoamine) (PAMAM) dendrimer-cross-linked polyimide membranes for gas separations. The poly(amidoamine) (PAMAM) dendrimer-cross-linked polyimide membranes with high selectivities described in the current invention were prepared from asymmetric aromatic polyimide membranes by chemical cross-linking using PAMAM dendrimer as the cross-linking agent (FIGS. 1-3). The PAMAM-cross-linked polyimide membranes showed significantly improved selectivities for CO₂/CH₄ compared to the un-cross-linked polyimide membranes. For example, PAMAM 0.0 dendrimer-cross-linked asymmetric flat sheet poly(3,3′,4,4′-diphenylsulfone tetracarboxylic dianhydride-3,3′,5,5′-tetramethyl-4,4′-methylene dianiline) (DSDA-TMMDA) polyimide membrane showed CO₂ permeance of 135.2 GPU and CO₂/CH₄ selectivity of 20.3. However, the un-cross-linked DSDA-TMMDA asymmetric flat sheet membrane showed much lower CO₂/CH₄ selectivity (16.5) and higher CO₂ permeance (230.8 GPU).

Cross-linking of asymmetric aromatic polyimide membranes by PAMAM dendrimer reduces polyimide polymer chain flexibility, which often results in greater differences in diffusivities between molecules of different sizes. The diffusion differences will allow greater selectivities, but reduce permeances. The PAMAM-cross-linked polyimide membranes have improved plasticization resistance and enhanced chemical stability compared to the un-cross-linked polyimide membranes.

The invention provides a process for separating at least one gas from a mixture of gases using the new PAMAM-cross-linked polyimide membranes with high selectivities described herein, the process comprising: (a) providing a PAMAM-cross-linked polyimide membrane described in the present invention which is permeable to said at least one gas; (b) contacting the mixture on one side of the PAMAM-cross-linked polyimide membrane to cause said at least one gas to permeate the membrane; and (c) removing from the opposite side of the membrane a permeate gas composition comprising a portion of said at least one gas which permeated said membrane.

The new PAMAM-cross-linked polyimide membranes with high selectivities are not only suitable for a variety of liquid, gas, and vapor separations such as desalination of water by reverse osmosis, non-aqueous liquid separation such as deep desulfurization of gasoline and diesel fuels, ethanol/water separations, pervaporation dehydration of aqueous/organic mixtures, CO₂/CH₄, CO₂/N₂, H₂/CH₄, O₂/N₂, H₂S/CH₄, olefin/paraffin, iso/normal paraffins separations, and other light gas mixture separations, but also can be used for other applications such as for catalysis and fuel cell applications.

### BRIEF DESCRIPTION OF THE DRAWINGS

FIG. 1a shows the polymer structure used in the examples.

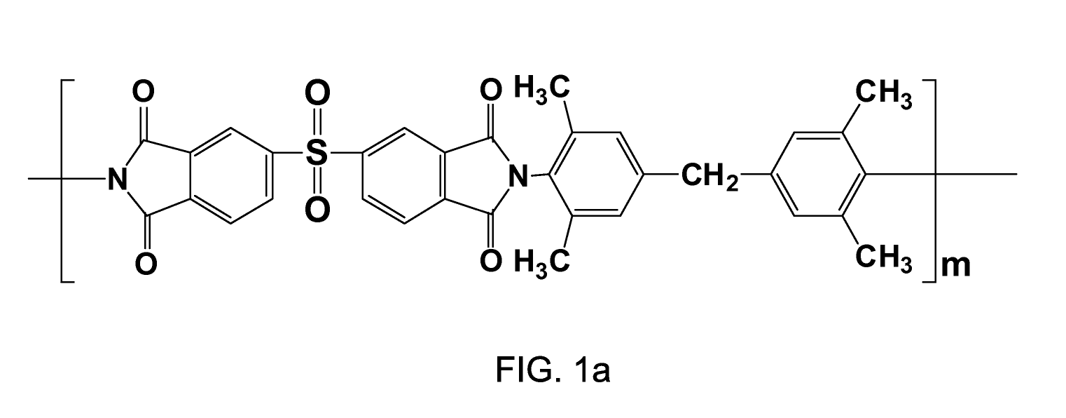

FIG. 1b shows the poly(amidoamine) dendrimer structure and the values of n in the dendrimer structure.

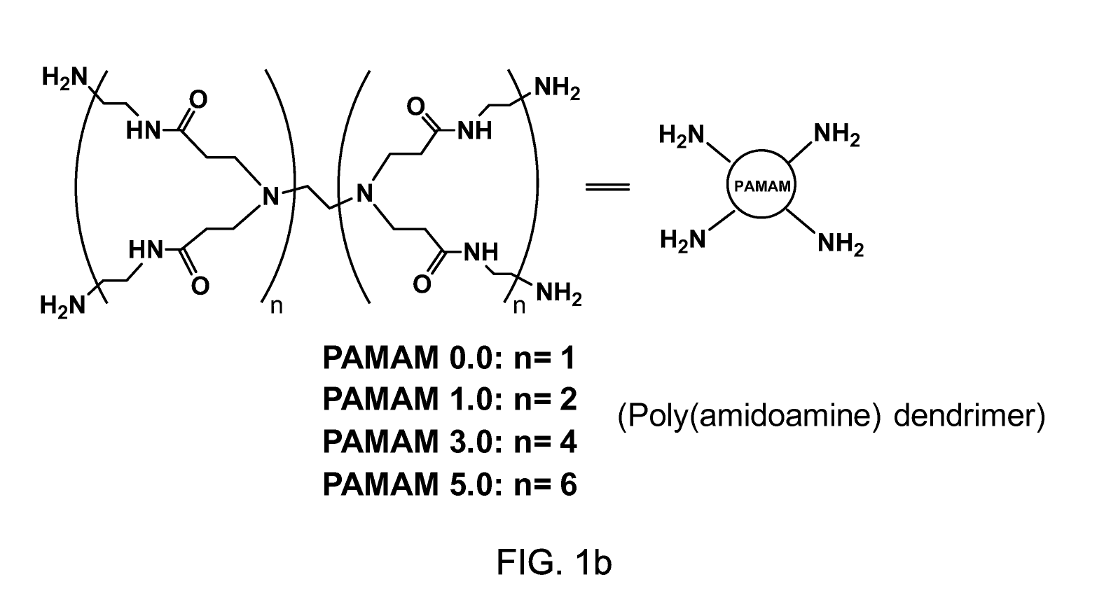

FIG. 2 shows the formation of a specific type of PAMAM dendrimer cross-linked DSDA-TMMDA polyimide membrane.

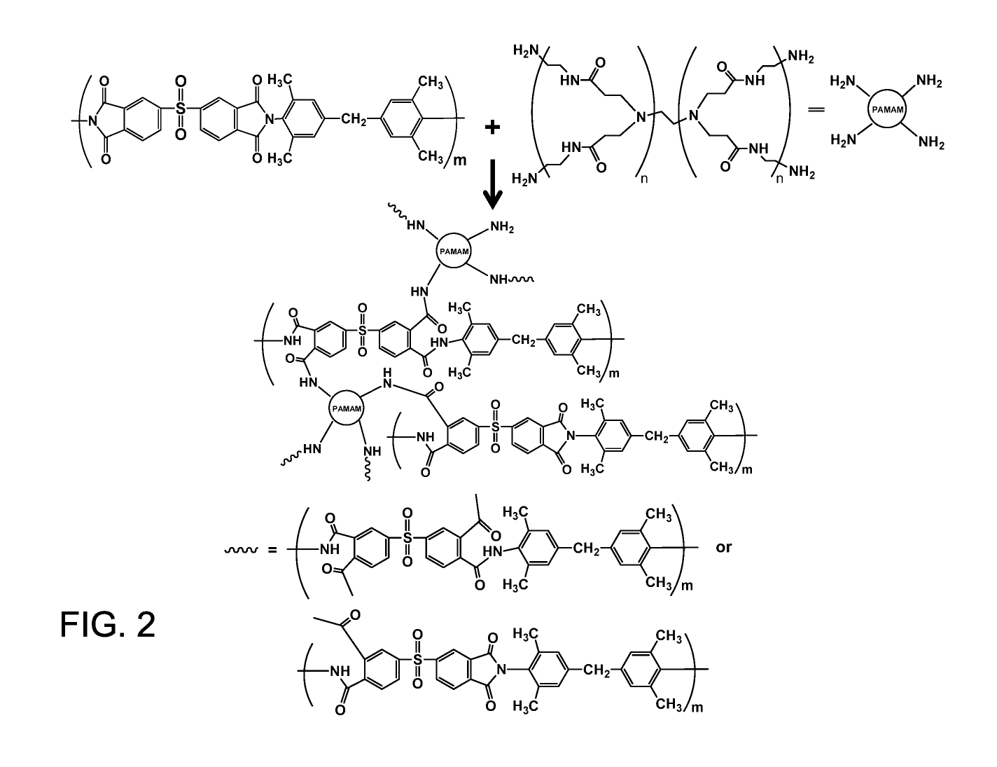

FIG. 3 shows the formation of a generic PAMAM dendrimer cross-linked polyimide membrane.

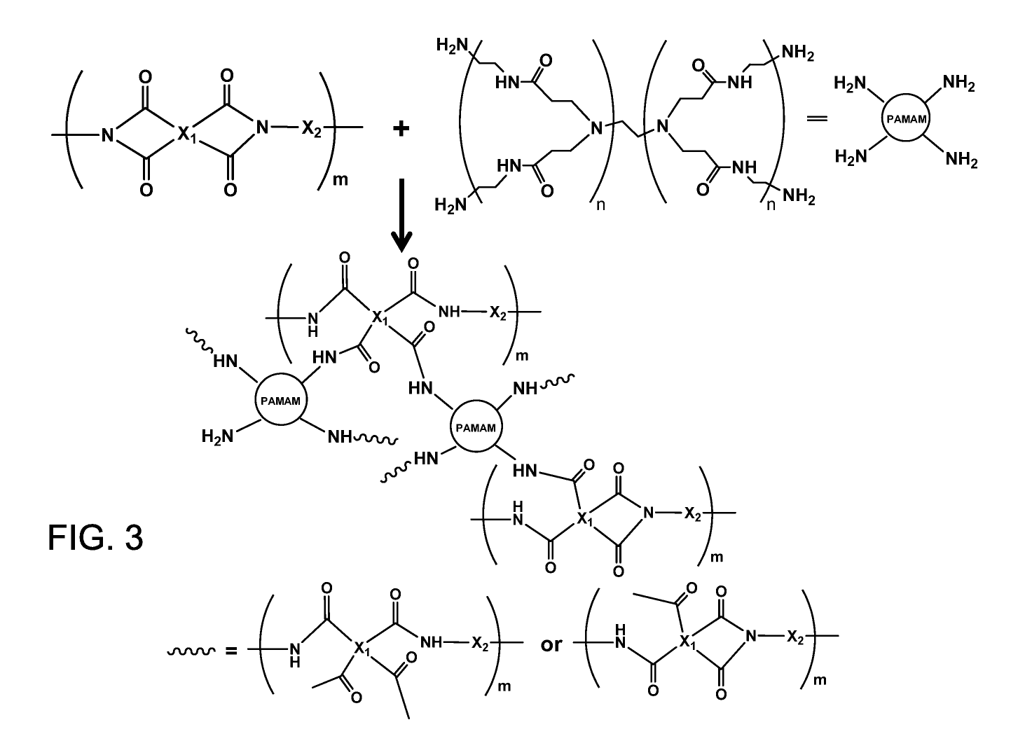

### EXAMPLES

The following examples are provided to illustrate one or more embodiments of the invention, but the invention is not limited to these embodiments. Numerous variations can be made to the following examples that lie within the scope of the invention.

### Example 1

### Preparation of PAMAM 0.0 Cross-Linked DSDA-TMMDA Polyimide Membrane (PI-PAMAM-0.01)

A 1 wt % PAMAM 0.0 cross-linking solution was prepared by mixing 0.56 g of poly(amidoamine) generation 0.0 (PAMAM 0.0) dendrimer solution (62.35 wt % PAMAM 0.0 in methanol) and 34.44 g of DI water. A low selectivity, high permeance, porous asymmetric flat sheet poly(3,3′,4,4′ -diphenylsulfone tetracarboxylic dianhydride-3,3′,5,5′-tetramethyl-4,4′-methylene dianiline) (DSDA-TMMDA) polyimide membrane with CO₂ permeance of 640 GPU and CO₂/CH₄ selectivity of 1.72 at 50° C. with a 10% CO₂ and 90% CH₄ mixed gas feed and the feed at 791 kPa (100 psig) was prepared for the cross-linking study. The skin layer surface of the DSDA-TMMDA membrane was contacted with the 1 wt % PAMAM 0.0 cross-linking solution for 1 min. The resulting membrane was then dried at 70° C. for 1 hour.

The surface of the PAMAM 0.0-cross-linked DDSDA-TMMDA membrane was dip coated with a 5 wt % RTV615A/615B silicone rubber solution. The coated membrane was dried inside a hood at room temperature for 30 min and then dried at 70° C. for 1 hour. The 5 wt % RTV615A/615B silicone rubber solution was prepared from 0.9 g of RTV615A, 0.1 g of RTV615B and 19 g of hexane. The dried PAMAM 0.0 cross-linked DSDA-TMMDA polyimide membrane (abbreviated as PI-PAMAM-0.01) was cut into 7.6 cm diameter circles for permeation testing.

### Example 2

### Preparation of PAMAM 0.0 Cross-Linked DSDA-TMMDA Polyimide Membrane (PI-PAMAM-0.02)

A 2 wt % PAMAM 0.0 cross-linking solution was prepared by mixing 2.25 g of poly(amidoamine) generation 0.0 (PAMAM 0.0) dendrimer solution (62.35 wt % PAMAM 0.0 in methanol) and 67.75 g of DI water. A low selectivity, high permeance, porous asymmetric flat sheet poly(3,3′,4,4′-diphenylsulfone tetracarboxylic dianhydride-3,3′,5,5′-tetramethyl-4,4′-methylene dianiline) (DSDA-TMMDA) polyimide membrane with CO₂ permeance of 640 GPU and CO₂/CH₄ selectivity of 1.72 at 50° C. with a 10% CO₂ and 90% CH₄ mixed gas feed and the feed at 791 kPa (100 psig) was prepared for the cross-linking study. The skin layer surface of the DSDA-TMMDA membrane was contacted with the 2 wt % PAMAM 0.0 cross-linking solution for 5 min. The resulting membrane was then dried at 70° C. for 1 hour.

The surface of the PAMAM 0.0-cross-linked DDSDA-TMMDA membrane was dip coated with a 5 wt % RTV615A/615B silicone rubber solution. The coated membrane was dried inside a hood at room temperature for 30 min and then dried at 70° C. for 1 hour. The 5 wt % RTV615A/615B silicone rubber solution was prepared from 0.9 g of RTV615A, 0.1 g of RTV615B and 19 g of hexane. The dried PAMAM 0.0 cross-linked DSDA-TMMDA polyimide membrane (abbreviated as PI-PAMAM-0.02) was cut into 7.6 cm diameter circles for permeation testing.

### Example 3

### Preparation of “Control” Un-Cross-Linked DSDA-TMMDA Polyimide Membrane (PI-0.05)

The surface of a low selectivity, high permeance, porous asymmetric flat sheet poly(3,3′,4,4′-diphenylsulfone tetracarboxylic dianhydride-3,3′,5,5′-tetramethyl-4,4′-methylene dianiline) (DSDA-TMMDA) polyimide membrane with CO₂ permeance of 640 GPU and CO₂/CH₄ selectivity of 1.72 at 50° C. with a 10% CO₂ and 90% CH₄ mixed gas feed and the feed at 791 kPa (100 psig) was dip coated with a 5 wt % RTV615A/615B silicone rubber solution. The coated membrane was dried inside a hood at room temperature for 30 min and then dried at 70° C. for 1 hour. The 5 wt % RTV615A/615B silicone rubber solution was prepared from 0.9 g of RTV615A, 0.1 g of RTV615B and 19 g of hexane. The dried RTV615A/RTV615B coated DSDA-TMMDA polyimide membrane (abbreviated as PI-0.05) was cut into 7.6 cm diameter circles for permeation testing.

### Example 4

### CO₂/CH₄ Separation Performances of PI-PAMAM-0.01, PI-PAMAM-0.02, and PI-0.05Si Membranes

The PI-PAMAM-0.01, PI-PAMAM-0.02, and PI-0.05Si membranes prepared in Examples 1-3 were tested for CO₂/CH₄ separation at 50° C. under 6996 kPa (1000 psig) mixed gas feed pressure with 10% CO₂ in the feed. The results in the following Table show that both the new PAMAM cross-linked membranes PI-PAMAM-0.01 and PI-PAMAM-0.02 have significantly higher CO₂/CH₄ selectivity than the un-cross-linked PI-0.05Si membrane. The CO₂ permeances of the PAMAM cross-linked membranes are higher than 82 GPU (5 A.U.) although they are lower than that of the un-cross-linked PI-0.05Si membrane.

TABLE
CO₂/CH₄ separation performances of PI-PAMAM-0.01,
PI-PAMAM-0.02, and PI-0.05Si membranes^{a}

| Asymmetric flat sheet membrane | P_{CO2}/L (GPU) | α_{CO2/CH4} |
|---|---|---|
| PI-0.05Si | 230.8 | 16.5 |
| PI-PAMAM-0.01 | 135.2 | 20.3 |
| PI-PAMAM-0.02 | 91.2 | 22.4 |

^{a}Tested at 50° C. under 6996 kPa (1000 psig) mixed gas pressure, 10% CO₂; 1 GPU = 7.5 × 10⁻⁹ m³ (STP)/m² s (kPa)

1. A polymer membrane comprising a poly(amidoamine) dendrimer-cross-linked polyimide.

2. The polymer membrane of claim 1 wherein said poly(amidoamine)-cross-linked polyimide is represented by a formula 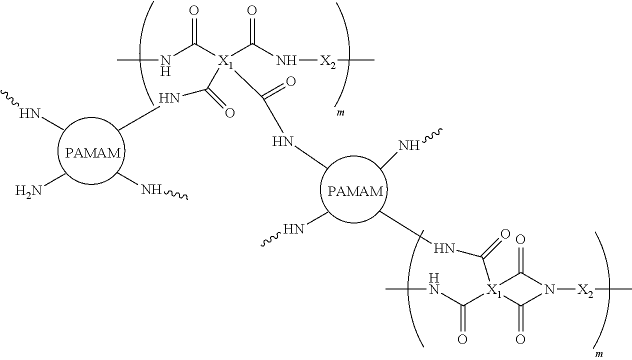
wherein said PAMAM structure is represented by 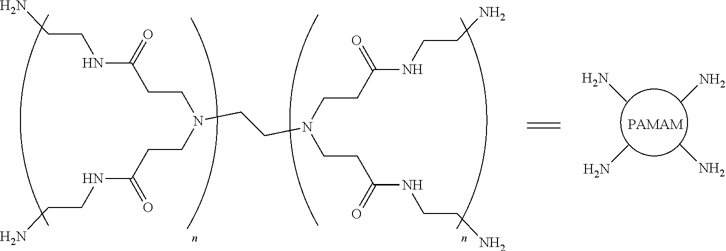
wherein said [symbol] is represented by 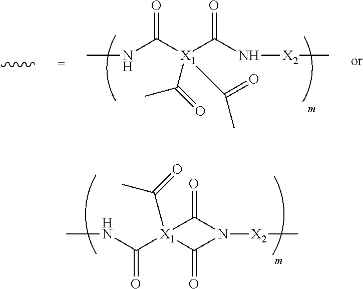
and wherein n is an integer from 1 to 10.

3. The polymer membrane of claim 1 wherein said polymer is represented by a formula comprising 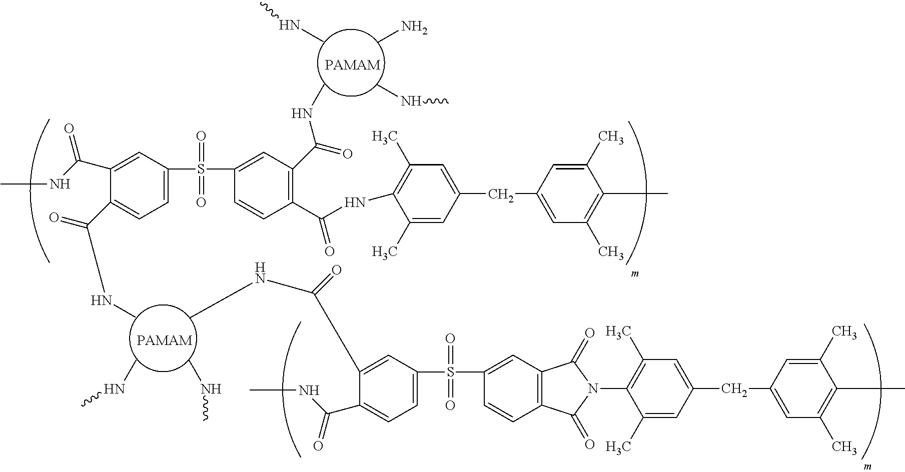
wherein said PAMAM structure is represented by 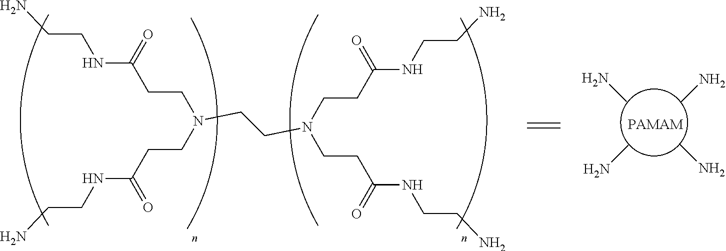
wherein said [symbol] is represented by 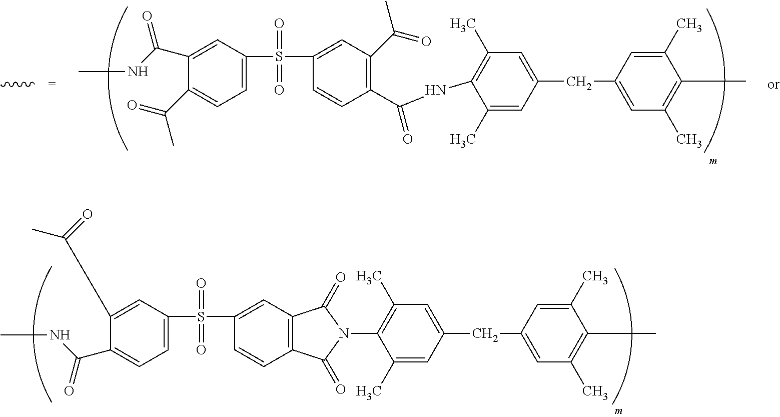
and wherein n is an integer from 1 to 10.

4. The polymer membrane of claim 1 wherein said polyimide has a structure comprising

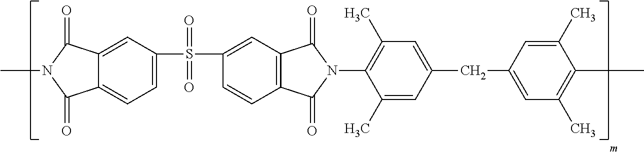

5. The polymer membrane of claim 1 wherein said poly(amidoamine) dendrimer is represented by

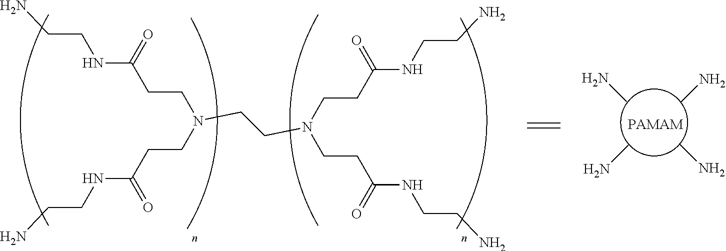

6. A process for separating at least one gas from a mixture of gases comprising:
(a) providing a poly(amidoamine)dendrimer-cross-linked polyimide membrane that is permeable to said at least one of said gases;
(b) contacting the mixture on one side of the membrane to cause said at least one of said gases to permeate the membrane; and
(c) removing from the opposite side of the membrane a permeate gas composition comprising a portion of said at least one of said gases which permeated said membrane.

7. The process of claim 6 wherein said poly(amidoamine)dendrimer-cross-linked polyimide membrane is represented by 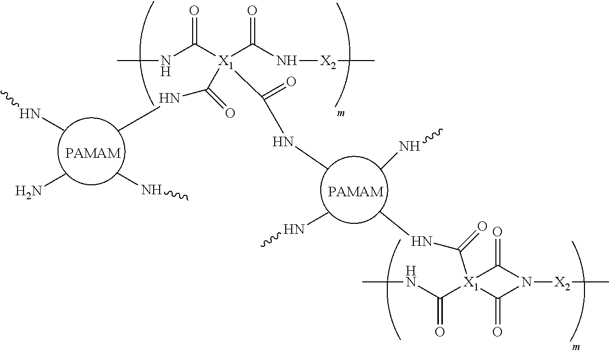
wherein said PAMAM structure is represented by 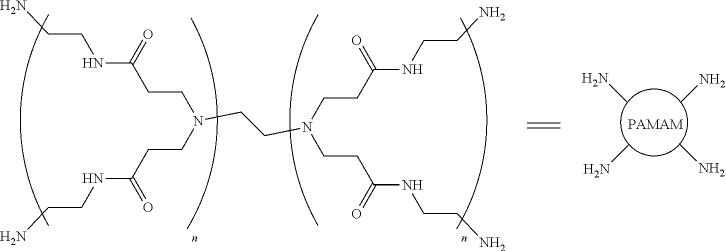
wherein said [symbol] is represented by 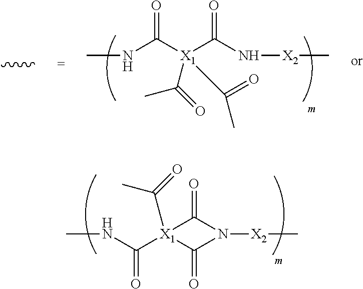
and wherein n is an integer from 1 to 10.

8. The process of claim 6 wherein said poly(amidoamine) dendrimer-cross-linked polyimide membrane is represented by 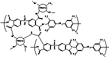
wherein said PAMAM structure is represented by 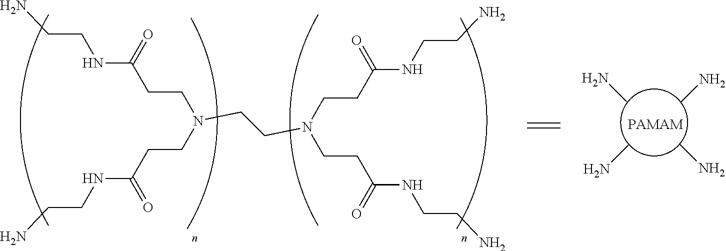
wherein said [symbol] is represented by 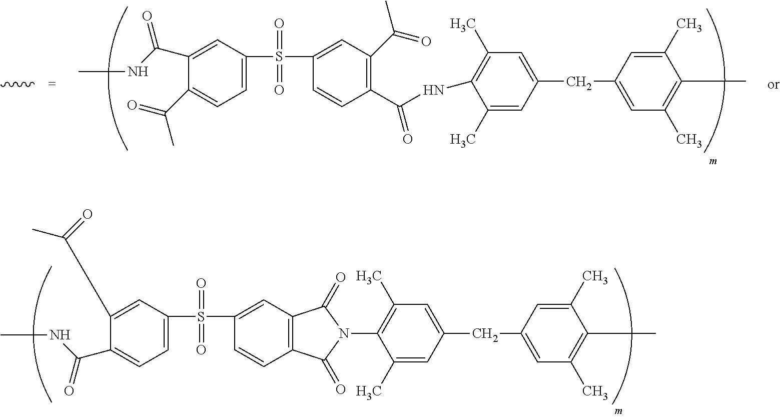
and n is an integer from 1 to 10.

9. The process of claim 6 wherein said membrane is fabricated into a sheet, tube or hollow fibers.

10. The process of claim 6 wherein said membrane has a higher selectivity than said polyimide membrane before being crosslinked with said poly(amidoamine) dendrimer.

11. The process of claim 6 wherein said gases are separated from natural gas and comprise one or more gases selected from the group consisting of carbon dioxide, hydrogen, oxygen, nitrogen, water vapor, hydrogen sulfide and helium.

12. The process of claim 11 wherein said gases are volatile organic compounds.

13. The process of claim 12 wherein said volatile organic compounds are selected from the group consisting of toluene, xylene and acetone.

14. The process of claim 6 wherein said gases comprise a mixture of carbon dioxide and at least one gas selected from hydrogen, flue gas and natural gas.

15. The process of claim 6 wherein said gases are a mixture of olefins and paraffins or iso and normal paraffins.

16. The process of claim 6 wherein said gases comprise a mixture of gases selected from the group consisting of nitrogen and oxygen, carbon dioxide and methane, hydrogen and methane or carbon monoxide, helium and methane.
